(19) United States
(12) Patent Application Publication
(10) Pub. No.: US 2022/0092427 A1
(43) Pub. Date: Mar. 24, 2022

(54) INTEGRATED GRAPH NEURAL NETWORK FOR SUPERVISED NON-OBVIOUS RELATIONSHIP DETECTION

(71) Applicant: INTERNATIONAL BUSINESS MACHINES CORPORATION, ARMONK, NY (US)

(72) Inventors: Phillipp Müller, Frankfurt (DE); Xiao Qin, San Jose, CA (US); Balaji Ganesan, Bangalore (IN); Berthold Reinwald, San Jose, CA (US); Nasrullah Sheikh, San Jose, CA (US)

(21) Appl. No.: 17/027,602

(22) Filed: Sep. 21, 2020

(51) Int. Cl. G06N 3/08; G06N 3/04

(52) U.S. Cl. CPC G06N 3/084; G06N 3/0454

(57) ABSTRACT

A method, a computer program product, and a system for non-obvious relationship detection. The method includes receiving a knowledge and inputting a first node and a second node from the knowledge graph into a twin neural network. The method also includes embedding the first node and the second node, aggregating neighborhood information and position information into the node embeddings. The method further includes concatenating the neighborhood information and the position information of the first node and the second node to produce a first output vector and a second output vector. The method also includes generating a final score by comparing the first output vector with the second output vector. The final score indicates a probability of a non-obvious relationship between the first node and the second node.

### STATEMENT REGARDING PRIOR DISCLOSURES BY THE INVENTOR OR A JOINT INVENTOR

The following disclosure(s) are submitted under 35 U.S.C. 102(b)(1)(A):

DISCLOSURE(S): Title: An Integrated Graph Neural Network for Supervised Non-obvious Relationship Detection in Knowledge Graphs, Authors: Phillipp Muller, Xiao Qin, Balaji Ganesan, Nasrullah Sheikh, and Berthold Reinwald, Publisher: EDBT 2020, 23^{rd} International Conference on Extending Database Technology, Date: Mar. 30, 2020.

### BACKGROUND

The present disclosure relates to non-obvious relationship detection, and more specifically, to supervised non-obvious relationship detection in knowledge graphs using an integrated graph neural network.

Non-obvious relationship detection involves examining attributes and connections relating to entities in a knowledge graph to find relationships between entities that are not explicitly defined in the data. Knowledge graphs are graph structures that represent relationships between entities for a given domain. In a knowledge graph (K.G.), nodes represent entities, edge labels represent types of relations, and edges represent existing relationships between two entities.

A graph neural network is a type of neural network that can directly operate on a graph structured data (e.g., a knowledge graph). Graph neural networks can effectively learn graph representations either on the node level or graph level by exploiting the node dependencies via message passing between levels. It can retain the states of nodes by incorporating information beyond their immediate neighbors such that the similarity in the embedding space approximates the similarity in the graph.

### SUMMARY

Embodiments of the present disclosure include a computer-implemented method for non-obvious relationship detection between two nodes in a knowledge graph. The computer-implemented method includes receiving a knowledge graph. The knowledge graph includes a plurality of nodes representing entities connected by edges representing relationships between the nodes. The computer-implemented method also includes inputting a first node and a second node from the knowledge graph into a twin neural network. The twin neural network includes two identical neural networks with shared parameters. The computer-implemented method further includes embedding attributes of the first node and attributes of the second node separately to generate a first node embedding and a second node embedding using a node attribute embedding layer in each of the identical neural networks. The computer-implemented method also includes aggregated neighborhood information onto the first node embedding and the second node embedding using at least one neighbor layer and aggregating position information onto the first node embedding and the second node embedding using at least one position layer. The computer-implemented method also includes concatenating the neighborhood information and the position information of the first node and the second node. A first output vector and a second output vector are produced with each vector including the initial embedding, neighborhood information, and position information of their respective node. The computer-implemented method also includes generating a final score by comparing the first output vector to the second output vector. The final score indicates a probability of a non-obvious relationship between the first node and the second node.

Additional embodiments of the present disclosure include a computer program product for non-obvious relationship detection between two nodes in a knowledge graph, which can include computer-readable storage medium having program instructions embodied therewith, the program instruction executable by a processor to cause the processor to perform a method. The method includes receiving a knowledge graph. The knowledge graph includes a plurality of nodes representing entities connected by edges representing relationships between the nodes. The method also includes inputting a first node and a second node from the knowledge graph into a twin neural network. The twin neural network includes two identical neural networks with shared parameters. The method further includes embedding attributes of the first node and attributes of the second node separately to generate a first node embedding and a second node embedding using a node attribute embedding layer in each of the identical neural networks. The method also includes aggregated neighborhood information onto the first node embedding and the second node embedding using at least one neighbor layer and aggregating position information onto the first node embedding and the second node embedding using at least one position layer. The method also includes concatenating the neighborhood information and the position information of the first node and the second node. A first output vector and a second output vector are produced with each vector including the initial embedding, neighborhood information, and position information of their respective node. The method also includes generating a final score by comparing the first output vector to the second output vector. The final score indicates a probability of a non-obvious relationship between the first node and the second node.

Further embodiments are directed to a system for non-obvious relationship detection between two nodes in a knowledge graph and configured to perform the methods described above. The present summary is not intended to illustrate each aspect of, every implementation of, and/or every embodiment of the present disclosure.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a knowledge graph matcher system, in accordance with embodiments of the present disclosure.

FIG. 2 is an exemplary knowledge graph, in accordance with embodiments of the present disclosure.

FIG. 3 is a flow diagram illustrating a non-obvious relationship detection process, in accordance with embodiments of the present disclosure.

FIG. 4 is a high-level block diagram illustrating an example computer system that may be used in implementing one or more of the methods, tools, and modules, and any related functions, described herein, in accordance with embodiments of the present disclosure.

FIG. 5 depicts a cloud computing environment, in accordance with embodiments of the present disclosure.

FIG. 6 depicts abstraction model layers, in accordance with embodiments of the present disclosure.

While the present disclosure is amenable to various modifications and alternative forms, specifics thereof have been shown by way of example, in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to non-obvious relationship detection, and more specifically, to supervised non-obvious relationship detection in knowledge graphs using an integrated graph neural network. While the present disclosure is not necessarily limited to such applications, various aspects of the disclosure may be appreciated through a discussion of various examples using this context.

Non-obvious relationship detection involves examining attributes and connections relating to entities in a knowledge graph to find relationships between entities that are not explicitly defined in the data. Knowledge graphs are graph structures that represent relationships between entities for a given domain. In a knowledge graph (KG), nodes represent entities, edge labels represent types of relations, and edges represent existing relationships between two entities.

A graph neural network is a type of neural network that can directly operate on a graph structure (e.g., a knowledge graph). Additionally, graph neural networks can capture the dependence of graphs via message passing between the nodes of the graph. Graph neural networks can also retain a state that can represent information from its neighborhood based on an arbitrary depth.

Enterprises are equipped with modern computing power and can excel at storing entities of interest as well as their relationships generated from daily transactions or operations in the form of a knowledge graph. There is increasing importance in attempting to understand this information to enable new services. Non-obvious relationship detection can detect relationships between entities in knowledge graphs in instances where the relationships are not explicitly defined in the data that enterprises can use. In some instances, non-obvious relationship detection systems can be designed to detect instances of credit card fraud, identifying fake identities, and the like.

Limitations on non-obvious relationship detection remain, however, as current implementations only focus on entity attributes or on certain aspects of the structural graph information. By only focusing on particular information, detecting whether two entities share a non-obvious relationship (e.g., a fake identity pair) can raise various challenges. First, the attribute information of an entity can be important in characterizing an entity. These attributes are typically expressed in heterogeneous data structures. However, extracting useful features from these data structures and constructing a unified representation from the attributes through manual feature engineering can be tedious and, at times, ineffective.

Second, two related entities may not share similar attribute properties. For example, to circumvent a registration system, a fake identity can be disguised with a completely different demographic and contact information. To counter this issue, a system can take the surrounding context into consideration. The “neighbors” of the entities of interest in a knowledge graph can provide useful information to a non-obvious relationship detection system in detecting a non-obvious relationship.

Third, entities that share a non-obvious relationship typically have a high degree of separation in a knowledge graph. To factor the separation in making a non-obvious determination, a system can capture the global position information of the entities in the context of the entire graph so that the distanced separation can be identified and factored.

Embodiments of the present disclosure may overcome the above and other problems by using a knowledge graph matcher (“KGMatcher”) system for non-obvious relationship detection using a neural model. By doing so, the KGMatcher system can automatically extract important features from a knowledge graph. The features encode the information regarding their entity attributes, neighborhood, and global position for predicting a non-obvious relationship between two entities.

More specifically, the KGMatcher system can include three types of neural layers that are connected and can be trained end-to-end. In some embodiments, attribute features are extracted by attribute node attribute embedding layers that support heterogeneous attribute types. The dense representation of the entities generated from these layers, as well as the edge information, can be fed into two stacks of graph layers. The first type of graph layers, a neighborhood layer, that can focus on extracting near-by neighborhood information by aggregating their attribute embeddings into the entity of interest. The second type of graph layers, a position layer, can focus on obtaining global position information of the entities by referring the entities to a set of sampled entity anchors.

The outputs of the graph layers can then be combined through a concatenation process to form final feature vectors of the entities. Additionally, the KGMatcher system can operate the form of a twin neural network for predicting the existence of a non-obvious relationship between two input entities.

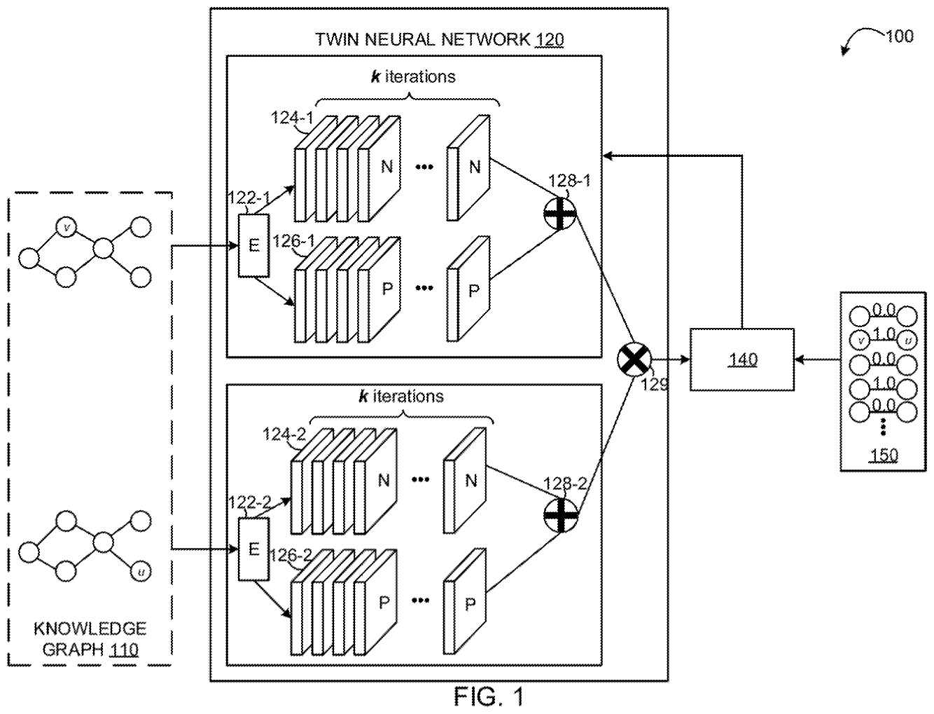

Referring now to FIG. 1, shown is a high-level block diagram of a KGMatcher system 100 for non-obvious relationship detection in knowledge graphs. The KGMatcher system 100 includes a knowledge graph 110, a twin neural network 120, a performance measurer 140, and training dataset 150. The twin neural network 120 includes node attribute embedding layers 122-1, 122-2 (collectively “node attribute embedding layers 122”), neighbor layers 124-1, 124-2 (collectively “neighbor layers 124”), position layers 126-1, 126-2 (collectively (“position layers 126”), merging components 128-1, 128-2 (collectively “merging components 128”), and a scoring component 129.

The knowledge graph 110 is input data of the KGMatcher 100 that includes a plurality of nodes and one or more edges, where each node reflects an entity, and each edge reflects an attribute describing a relationship between the entities. In some embodiments, the knowledge graph 110 is a knowledge graph that represents the relationships between entities for a given domain. In a knowledge graph (K.G.), nodes represent entities, edge labels represent types of relations, and edges represent existing relationships between two entities. Subgraphs can also represent the relationship between entities in an entity subclass. An entity may represent a person (e.g., Thomas J. Watson), a place (e.g., Seattle, Tex., a street, address, etc.), or thing (e.g., book, label, monitor, attorney, paper, tree, etc.) By way of example, but not by limitation, an entity may be an organization, a political body, a business, a governmental body, a date, a number, a letter, an idea, or any combination thereof.

Additionally, an entity may be associated with an entity class. An entity class may represent a categorization, type, or classification of a group or notional model of entities. For example, an entity class may include “person,” “racecar driver,” “species,” “monument,” “president,” and the like. An entity class may also be associated with one or more subclasses. A subclass can reflect a class of entities subsumed in a larger class. For example, the classes “racecar driver” and “president” may be subclasses of the class “person” because all racecar drivers and presidents are human beings. As used herein, the term “entity” may be associated with or refer to an entity class, subclass, instance thereof, a standalone entity, or any other entity consistent with the disclosed embodiments.

Entities can also be associated with one or more entity attributes and/or object attributes. An entity attribute may reflect a property, trait, characteristic, quality, or element of an entity class. Entity classes can share a common set of entity attributes. For example, the entity “person” may be associated with entity attributes “birth date,” “place of birth,” “gender,” “age,” and the like. In another example, the entity “professional sports team” may be associated with entity attributes such as “location,” “annual revenue,” “roster,” and the like. As used herein, “node attribute” may be associated with or refer to the entity attributes of an entity represented as a node in a K.G.

A context may reflect a lexical construction or representation of one or more words (e.g., a word, phrase, clause, sentence, paragraph) imparting meaning to one or more words (e.g., an entity) in its proximity. A context may be represented as an n-gram. An n-gram reflects a sequence of n-words, where n is a positive integer. For example, a context may include 1-gram such as “is,” “was,” or “has.” Additionally, contexts may include 3-grams such as “was born on,” “is married to,” “has been to.” As described herein, an n-gram represents any such sequence, and two n-grams need not have the same number of words. For example, “scored a goal” and “in the final minute” may constitute n-grams, despite containing a different number of words.

A context may also indicate the potential presence of one or more entities. The one or more potential entities specified by a context may be herein referred to as “context classes” or “context entities,” although these designations are for illustrative purposes only and are not intended to be limiting. Context classes can reflect a set of classes typically arising in connection with (e.g., having a lexical relationship with) the context. In some embodiments, “context classes” may reflect specific entity classes. For example, the context “is married to” may be associated with a context class of entity “person,” because the context “is married to” usually has a lexical relationship to human beings (e.g., has a lexical relationship to instances of the “person” class).

The twin neural network 120 is a component of the KGMatcher system 100 configured to use the same weights while working in tandem on two different input vectors to compute comparable output vectors (e.g., nodes in the knowledge graph 110. The twin neural network 120 can operate the node attribute embedding layers 122, the neighbor layers 124, the position layers 126, and the merging components 128 in tandem as each of the layers evaluates an inputted entity from the knowledge graph 110.

The node attribute embedding layers 122 are components of the twin neural network 120 configured to encode entities, and their corresponding entity attributes into fixed-length vectors. The node attribute embedding layers 122 can perform various types of embedding techniques. These embedding techniques include, for example, conventional word representation, pre-trained contextualized word representation, and multiple granularity. Conventional word representation and pre-trained contextualized representation techniques can be used to produce the embeddings. Additionally, to encode semantic and linguistic information, multiple granularity, which fuses word-level embeddings with character-level embeddings, part-of-speech, name entity, word frequency, question category, and so on, can also be used. In some embodiments, two bidirectional LSTMs are used to encode the knowledge graph 110. One LSTM can be used to encode the nodes and another one for the edges. The concatenation of the last forward and backward hidden states of the bidirectional LSTMs can be used as the initial embeddings for the nodes as well as the edges.

Conventional word representation techniques include, for example, One-Hot and distributed word representation. The One-Hot encoding method represents words with binary vectors, and its size is the same as the number of words in the dictionary being used. In the vectors, one position is 1, corresponding to the word, while the others are 0. The distributed word representation method encodes words into continuous low-dimensional vectors. Closely related words encoded by these methods are close to each other in a vector space, which reveals a correlation of words. Distributed word representation techniques include, for example, Word2Vec and GloVe.

Pre-trained contextualized word representation techniques include context vectors (CoVE), embeddings from language models (ELMo), generative pre-training (G.P.T.), and bidirectional encoder representation from transformers (BERT). Pre-trained contextualized word representation techniques, such as those listed above, are typically pre-trained with a large corpus in advance and then directly used as conventional word representations or trained according to the specific tasks.

Multiple granularity techniques include character embeddings, part-of-speech tags, name-entity tags, binary feature of exact match (E.M.), and query-category. These techniques can incorporate fine-grained semantic information into word representations. For example, character embeddings represent words at the character level. Each character in a word is embedded into a fixed-dimension vector, which is fed into a CNN. After max-pooling the entire width, the output of the CNN are embeddings at the character level. In addition, character embeddings can be encoded with bidirectional LSTMs. For each word, the outputs of the last hidden state are considered to be its character-level representation. Word-level and character-level embeddings can be combined dynamically with a gating mechanism in place of a simple concatenation to mitigate the imbalance in word frequency.

The attribute information associated with each entity in the knowledge graph 110 can be a mixture of structure, semi-structured, and/or unstructured data. By leveraging the existing deep learning-based embedding method as described above, the node attribute embedding layers 122 can convert the entity attributes into a vector representation. First, depending upon the specific type of attribute, a neural architecture can be chosen to produce the embedding in an unsupervised or supervised manner. For example, to process “text” type attributes, the vector representation can be generated from a pre-trained language model such as XLNet. This unsupervised strategy can ensure the generality of the embedding since the pre-trained model is usually obtained from a large general domain corpus.

In some embodiments, the node attribute embedding layers 122 generate embeddings that also maximize the accuracy of the entity matching. Other neural networks can be connected to the KGMatcher system 100 and the layers, which can be adjusted through backpropagation from the feedback on the relationship prediction. The connected node attribute embedding layers 122 can be either initialized by the pre-trained parameters (e.g., weights) and fine-tuned onward or randomly initialized and trained from scratch. In some embodiments, the node attribute embedding layers 122 concatenate each of the embeddings of the whole attribute set of an entity, which is then fed to the next layers.

The neighbor layers 124 are components of the twin neural network 120 configured to aggregate neighborhood information of an inputted embedding vector of an entity from the knowledge graph 110. Each node in the knowledge graph 110 can aggregate embedding vectors of its immediate neighbors to compute a new embedding vector containing the neighborhood information. After a predetermined number of iterations of aggregation, a node is represented by its transformed embedding vector, which captures the surrounding information within the node's k-hop distance. The neighbor layers 124 can utilize a variety of graph neural network techniques. These graph neural network techniques include, for example, inductive graph neural networks where only the aggregate and combine for a node are learned.

In some embodiments, GraphSage layers are used as the neighbor layers 124. GraphSage is a spatial-based graph neural network that models the graph topology through neighbor aggregation. The aggregated information can be based on the node attributes. The GraphSage layers can implement an aggregate function as defined by Equation 1 below:

aᵥ_{ᵢ}^{(k)}=max({ReLU(Wₐ^{N}·hᵥ_{ᵢ}^{(k-1)}|u∈Neighbor(vᵢ)})) Equation 1

Let G=(V,E) denote the knowledge graph 110 where V {v₁, . . . , vₙ} is a set of nodes with each node representing an entity and E={e₁, . . . , eₙ} is a set of edges with each edge eₖ=(vᵢ, vⱼ) indicating a connection between two entities vᵢ and vⱼ. Let A={a₁, . . . aₙ} define a set of attributes associated with each entity vᵢ. Each entity vᵢ={xₐ_{₁}ⁱ, . . . , xₐ_{ₖ}ⁱ} follows the same schema with the attribute types defined by A where xₐ_{ₖ}ⁱ denotes the kth attribute value of vᵢ. Where Wₐ^{N} is a learnable matrix, and max represents an element-wise max-pooling.

Additionally, the GraphSage layers can utilize a combine function as defined by Equation 2 below:

hᵥ_{ᵢ}^{(k)}=W_{c}^{N}·[hᵥ_{ᵢ}^{(k-1)},aᵥ_{ᵢ}^{(k)}] Equation 2

where W_{c}^{N} is a learnable matrix. The embedding vector of a node can be initialized by its attribute embedding vector obtained from the node attribute embedding layers 122.

The position layers 126 are components of the twin neural network 120 configured to capture the global position information for each entity in the knowledge graph 110. Each position layers 12 can produce an output vector of a node embedding containing global position information relating to the node. The position layers 126 can utilize an absolute position of a node that can be defined by its relative position to a set of reference nodes, or anchors, in the knowledge graph 110.

In some embodiments, the position layers 126 are implemented by a position-aware graph neural network (P-GNN). Typical GNN architectures fail to capture the position/location of a node within a broader context of the knowledge graph 110. For example, if two nodes reside in different parts of the knowledge graph 110 have topologically the same neighborhood structure, they will have an identical GNN structure. A P-GNN, however, can compute node embeddings that incorporate a node's positional information (e.g., global position) in respect to all other nodes in a network, while also retaining inductive capability and utilizing node features.

In some embodiments, the position layers 126 aggregate information for an embedded node from a set of anchor nodes. Each position layer 126 samples a set of anchor nodes as references from the graph and then computes the shortest distances from every embedded node to these sampled anchors to encode a distance metric. Each embedding dimension of a node can correspond to the combination of the node embedding and the aggregated information from a specific anchor or anchors, weighted by the distance metric. The weight can be inversely proportional to the distance. In some embodiments, the KGMatcher system 100 stacks multiple position layers 126 to achieve a higher expression power.

The position layers 126 can compute the aggregation for the Ith dimension for a node at a time k using Equation 3 defined below:

$${a}_{{v}_{i}^{l}}^{( k )} = mean ( \{ ReLU ( {W}_{a}^{P} \cdot ( s ( {v}_{i} , u ) \times {h}_{u}^{( k - 1 )} ) \vert u ∈ {Anchor}^{l} ( {v}_{i} ) \} ) ) \qquad Equation 3$$

and the combined embedding of vᵢ at time k can be computed using Equation 4 defined below:

$${h}_{{v}_{i}}^{( k )} = {W}_{t}^{P} \cdot [ … , {W}_{c}^{P} \cdot [ {h}_{{v}_{i}}^{( k - 1 )} , {a}_{{v}_{i}^{l}}^{( k )} ] , … ] \qquad Equation 4$$

where s(vᵢ,u) computes the weight of an anchor node u to the embedded node vᵢ, Anchor^{l} (vᵢ) returns a set of anchors dedicated to computing the embedding value on the Ith dimension of the embedded nodes. The lth dimension is represented by

$${W}_{c}^{P} \cdot [ {h}_{{v}_{i}}^{( k - 1 )} , {a}_{{v}_{i}^{l}}^{( k )} ] ,$$

mean represents an element-wise mean-pooling and Wₐ^{P}, W_{c}^{P} and Wₜ^{P} are learnable matrices. The weight computed by s(vᵢ, u) can be inversely proportional to the shortest distance between vᵢ and u in the knowledge graph 110.

The merging components 128 are components of the twin neural network 120 configured to form a single output vector of a node that encodes both neighborhood and position embedding information. The merging component can concatenate the embedding vector outputted by the neighbor layer 124 with the output vector produced by the position layer 126 to produce an output vector containing the information from both layers. In some embodiments, the merging components 128 concatenate the neighborhood embedding information from the neighbor layers 124 with the position embedding information from the position layers 126 after the predetermined iterations of the layers are performed. In some embodiments, the merging components 128 concatenate the neighborhood embedding information from the neighbor layers 124 with the position embedding information from the position layers 126 after each iteration the layers performed.

The scoring component 129 is a component of the twin neural network 120 configured to compute a final score based on a distance measure between the output vectors produced by the twin neural network 120. The final score can indicate the likelihood of the two entities sharing a non-obvious relationship. In some embodiments, the relationship between the two entities is defined as undirected. The twin neural network 120 can use the same weights while working in tandem on two different input vectors representing the entities. The result being two comparable output vectors that align with a symmetric property. The scoring component 129 can compute a dot product of the two output vectors to produce a final score indicating a probability of a non-obvious relationship between the two entities.

The performance measurer 140 is a component of the KGMatcher system 100 configured to measure the performance of the final score. In some embodiments, the performance measurer 140 is a binary cross-entropy loss function that measures the performance of the final score whose output is a probability value between 0 and 1. The binary cross-entropy loss increases as the predicted probability diverge from the actual label. For example, predicting a probability of 0.012 for a non-obvious relationship when the ground truth label of the relationship is 1 would result in a high loss value.

The training dataset 150 is a set of data used by the KGMatcher system 100 as training data for the twin neural network 120. The training dataset 150 includes a includes a collection of examples with each example containing one or more features and a label. In some embodiments, the training dataset 150 is divided into a training dataset, a validation dataset, and a test dataset. The validation dataset can be a subset of the training dataset 150 for use in validating a pseudo labeled dataset. The test dataset is a subset of the training dataset 150 used to test the KGMatcher system 100 after training and validation.

It is noted that FIG. 1 is intended to depict the representative major components of an exemplary KGMatcher system 100. In some embodiments, however, individual components may have greater or lesser complexity than as represented in FIG. 1, components other than or in addition to shoe shown in FIG. 1 may be present, and the number, type, and configuration of such components may vary.

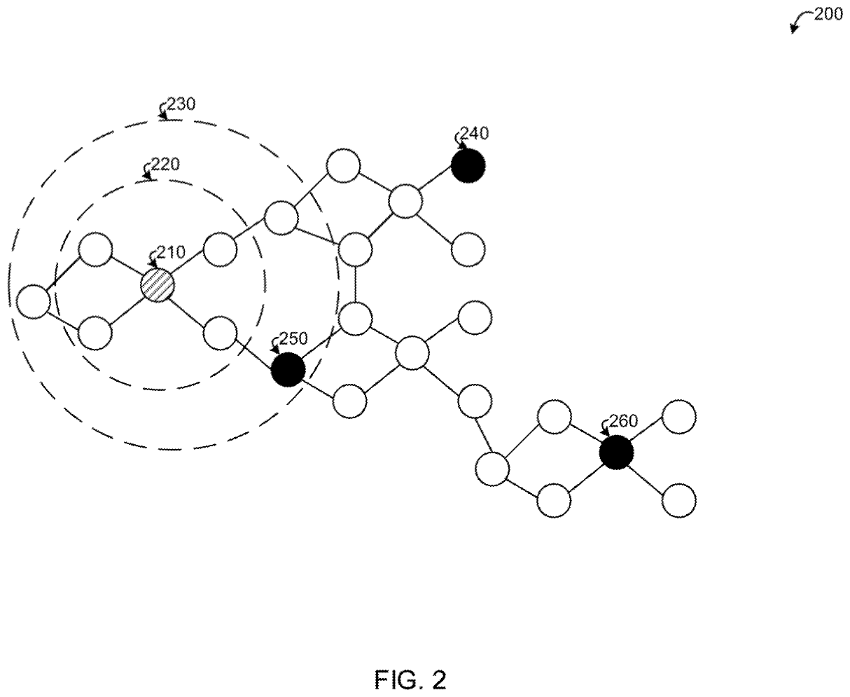

Referring now to FIG. 2, shown is an example knowledge graph 200, consistent with the disclosed embodiments. The knowledge graph may comprise a plurality of nodes, each node reflecting an entity. The knowledge graph can also include one or more edges reflecting attributes describing relationships between the entities and the values of particular attributes. An entity node may also be associated with entity classes and subclasses, connected via attributes, describing the nature of the relationship between an entity and an entity class. The knowledge graph 200 may be substantially similar to, or the same as, the knowledge graph 110 described in FIG. 1.

FIG. 2 depicts a node 210 within the knowledge graph 200 representing an entity with edge connections to four other nodes that represent a relationship to a corresponding entity of the node. Additionally, a neighborhood 220 illustrates a one-hop radius around the node 210 that the neighbor layers 124 can utilize when encoding, for example, node 210. The neighbor layers 124 can gather the information within the one-hop radius and encode each node's respective information into the embedding of node 210. Neighborhood 230 illustrates a two-hop radius around the node 210 that the neighbor layers 124 can also utilize when encoding neighborhood information. The neighbor layers 124 can be configured to encode based on a predetermined number of iterations away from a node and can be based on the type of knowledge graph 200 and the type of attribute information maintained by each node.

FIG. 2 also depicts node anchors 240, 250, and 260. The anchor nodes 240, 250, and 260 can be designated nodes within the knowledge graph 200 that represent global positioning information for each entity. For example, the position layers 126 can take the absolute position of the node 210 by determining a relative position to the anchor nodes 240, 250, and 260. In some embodiments, the positioning relates to the least number of iterations required to go from the node 210 to each respective anchor node 240, 250, and 260.

Specifically, instead of aggregating information from the immediate neighbors, the position layers 126 can aggregate information for the node 210 from the set of anchor nodes 240, 250, and 260. Each position layer 126 can sample a set of anchor nodes 240, 250, 260 as references from the knowledge graph 200 and compute the shortest distances from every embedded node to these sample anchors to encode a distance metric. Each embedding dimension of a node can correspond to the combined of node embedding and the aggregated information from a specific anchor(s) weighted by the distance metric. In some embodiments, the weight is inversely proportional to the distance.

FIG. 2 illustrates how the KGMatcher system 100 can use a knowledge graph 200 to gather surround information from the knowledge graph 200. The neighborhood information as represented by neighborhoods 220 and 230 as well the position information represented by the anchor nodes 240, 250, and 260 are exemplary representations to illustrate how KGMatcher system 100 can gather information when making a determination as to whether a non-obvious relationship exists between two nodes.

It is noted that FIG. 2 is intended to depict the representative major components of an exemplary knowledge graph 200. In some embodiments, however, individual components may have greater or lesser complexity than as represented in FIG. 2, components other than or in addition to shoe shown in FIG. 2 may be present, and the number, type, and configuration of such components may vary.

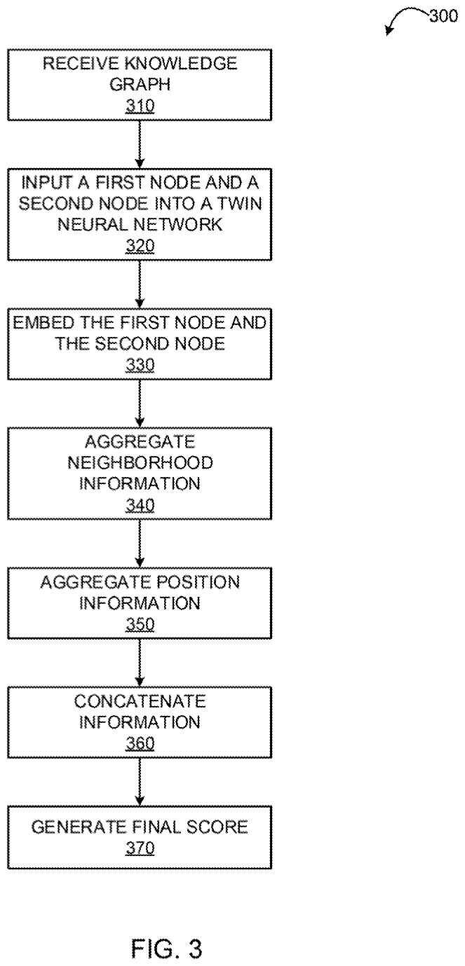

FIG. 3 is a flow diagram illustrating a process 300 of determining a non-obvious relationship between nodes in a knowledge graph, in accordance with embodiments of the present disclosure. The process 300 begins by receiving a knowledge graph 110 into the KGMatcher system 100. This is illustrated at step 310. The knowledge graph 110 can include a plurality of nodes and one or more edges. In the knowledge graph 110 the nodes can represent entities and each edge can represent a relationship between two connected entities.

A first node and a second node are inputted into a twin neural network 120 of the KGMatcher system 100. This is illustrated at step 320. The first node and the second node are nodes within the knowledge graph 110 that may not have an explicit relationship between the entities the nodes represent. For example, the first node and the second node may not be connected by an edge representing a relationship between the entities. The twin neural network 120 can include identical neural networks that share parameters between the two networks. The first node can be inputted into one of the identical neural networks and the second node can be inputted into the other identical neural network. By doing so, computation of the first node and the second node can occur simultaneously.

The node attribute embedding layer 122 for each of the identical neural networks computes an embeddings attributes of the first node and attributes of the second node. This is illustrated at step 330. In some embodiments, the embeddings are represented as fixed-length vectors. The node attribute embedding layers can perform the embedding using various embedding techniques such as conventional word representation, pre-trained contextualized word representation, and multiple granularity. Conventional word representation and pre-trained contextualized representation techniques can be used to produce the embeddings. Additionally, to encode semantic and linguistic information, multiple granularity, which fuses word-level embeddings with character-level embeddings, part-of-speech, name entity, word frequency, question category, and so on, can also be used.

The neighbor layer 124 for each of the identical neural networks aggregates neighborhood information onto the embeddings of the first node and the second node. This is illustrated at step 340. In some embodiments, the neighbor layer 124 is a plurality of neighbor layers 124 performing the aggregation in an iterative manner. For example, starting with the first node embedding and the second node embedding, the neighbor layers 124 aggregate the neighborhood information onto the first node embedding and the second embedding in an iterative manner, with a new first node embedding and a new second node embedding acting as an initial value that is applied to a subsequent neighbor layer 124 for a next iteration, until a predetermined number of iterations is performed.

In some embodiments, the neighborhood information includes node information that is one-hop distance away from each of the nodes. For example, the neighborhood information of the first node and the second node can be node information from nodes that have edges connecting the nodes to other nodes. In some embodiments, the neighborhood information includes node information that is two-hop distances away from each of the nodes. A two-hop distance can include nodes that are in direct relation with the first node and the second node, but also nodes that are in direct relation with those nodes as well. It should be noted that the neighborhood distance can be predetermined by an administrator and set to a hop distance optimal in determining a non-obvious relationship.

The position layer 126 for each of the identical neural networks aggregates position information onto the embeddings of the first node and the second node. This is illustrated at step 350. In some embodiments, the position layer 126 is a plurality of position layers 126 performing the aggregation in an iterative manner. For example, starting with the first node embedding and the second node embedding, the position layers 124 aggregate the global position information onto the first node embedding and the second embedding in an iterative manner, with a new first node embedding and a new second node embedding acting as an initial value that is applied to a subsequent position layer 126 for a next iteration, until a predetermined number of iterations is performed.

In some embodiments, the position layer 126 is a P-GNN capable of capturing the global position information of each node in the knowledge graph 110. The P-GNN can aggregate information for the embeddings from a set of anchor nodes within the knowledge graph 110. The P-GNN can sample a set of the anchor nodes as references from the graph and then compute the shortest distance from every embedded node to the anchor nodes to encode a distance metric. Each embedding dimension of a node can correspond to the combination of the node embedding and the aggregated information from a specific anchor node(s) weighted by the distance metric. The weight can be inversely proportional to the distance between the nodes and the anchor nodes.

The merging component 128 for each of the identical neural networks concatenates the neighborhood information embedding and the position information embedding to produce an output vector for each of the nodes. This is illustrated at step 360. In some embodiments, the merging components 128 concatenate the neighborhood embedding information from the neighbor layers 124 with the position embedding information from the position layers 126 after the predetermined iterations of the layers are performed. In some embodiments, the merging components 128 concatenate the neighborhood embedding information from the neighbor layers 124 with the position embedding information from the position layers 126 after each iteration the layers performed.

The scoring component 129 generates a final score representing a probability of a non-obvious relationship between the first node and the second node. This is illustrated at step 370. The scoring component 129 can compute a dot product of the two output vectors to produce a final score indicating a probability of a non-obvious relationship between the two entities. If the probability exceeds a predetermined threshold, then the first node and the second node have a non-obvious relationship. Otherwise, the KGMatcher system 100 can indicate that the first node and the second node do not have a non-obvious relationship. In some embodiments, the final score is a cosine distance between the first output vector and the second output vector. Cosine distance, or cosine similarity, is a measure of similarity between two non-zero vectors of an inner product space. It can be defined to equal the cosine of the angle between the two vectors, which is also the same as the inner product of the same vectors normalized to both have a length of one.

In some embodiments, an error of the final score is computed. The error can represent an absolute difference between the final score and a ground truth label in the training set 150. The ground truth label can indicate whether the non-obvious relationship exists between the first node and the second node. To determine whether or not to train the twin neural network, a backpropagation can be computed for the twin neural network using the error. Based on the backpropagation computed, the twin neural network can be retrained.

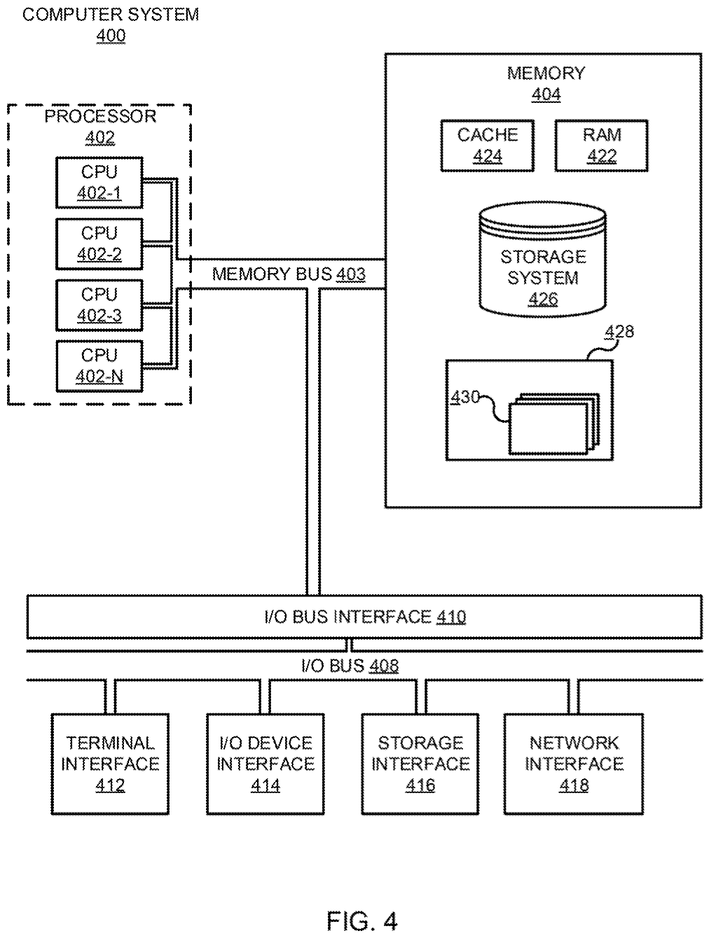

Referring now to FIG. 4, shown is a high-level block diagram of an example computer system 400 (e.g., the KGMatcher system 100) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 400 may comprise one or more processors 402, a memory 404, a terminal interface 412, an I/O (Input/Output) device interface 414, a storage interface 416, and a network interface 418, all of which may be communicatively coupled, directly or indirectly, for inter-component communication via a memory bus 403, an I/O bus 408, and an I/O bus interface 410.

The computer system 400 may contain one or more general-purpose programmable central processing units (CPUs) 402-1, 402-2, 402-3, and 402-N, herein generically referred to as the processor 402. In some embodiments, the computer system 400 may contain multiple processors typical of a relatively large system; however, in other embodiments, the computer system 400 may alternatively be a single CPU system. Each processor 401 may execute instructions stored in the memory 404 and may include one or more levels of on-board cache.

The memory 404 may include computer system readable media in the form of volatile memory, such as random-access memory (RAM) 422 or cache memory 424. Computer system 400 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

Although the memory bus 403 is shown in FIG. 4 as a single bus structure providing a direct communication path among the processors 402, the memory 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 400 may, in some embodiments, contain multiple I/O bus interface units, multiple I/O buses, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the major representative components of an exemplary computer system 400. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 (e.g., the KGMatcher system 100), may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

It is to be understood that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and P.D.A.s).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

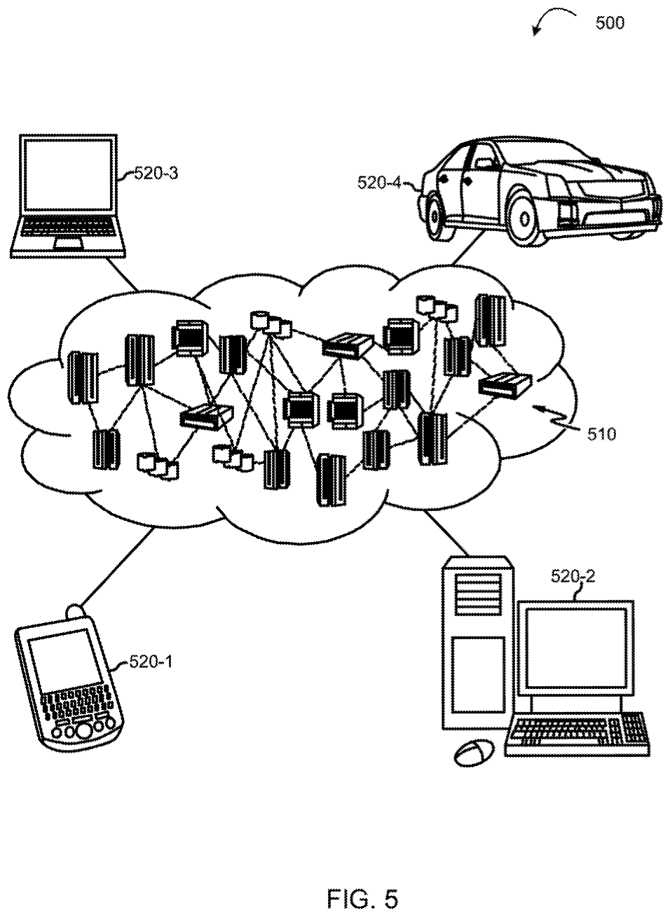

Referring now to FIG. 5, illustrative cloud computing environment 500 is depicted. As shown, cloud computing environment 500 includes one or more cloud computing nodes 510 with which local computing devices used by cloud consumers, such as, for example, personal digital assistant (P.D.A.) or cellular telephone 520-1, desktop computer 520-2, laptop computer 520-3, and/or automobile computer system 520-4 may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 520-1 to 520-4 shown in FIG. 5 are intended to be illustrative only and that computing nodes 510 and cloud computing environment 500 can communicate with any type of computerized device over any type of network and/or network addressable connection (e.g., using a web browser).

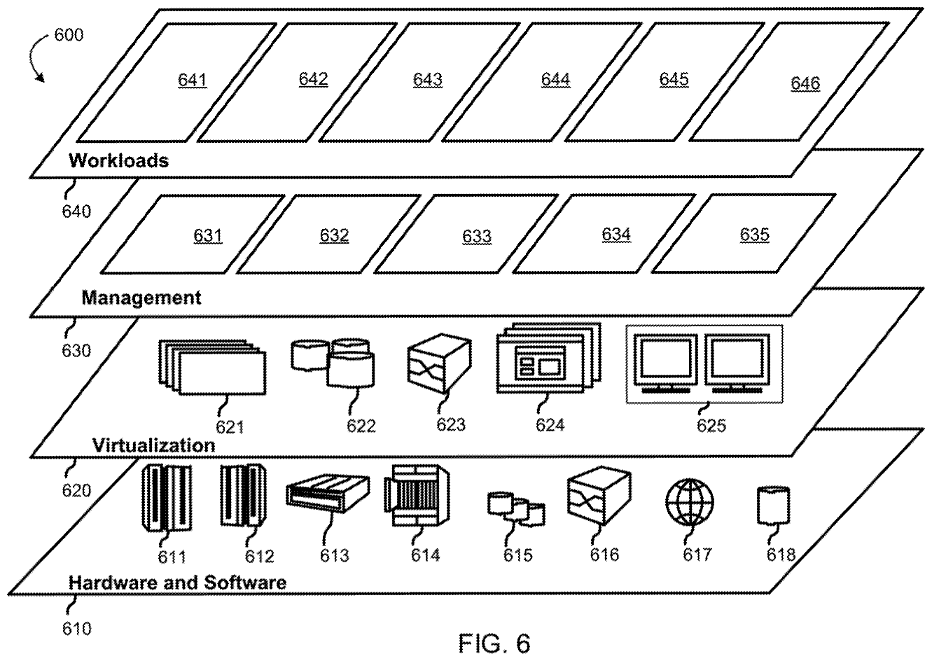

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 includes hardware and software components. Examples of hardware components include mainframes 611; RISC (Reduced Instruction Set Computer) architecture-based servers 612; servers 613; blade servers 614; storage devices 615; and networks and networking components 616. In some embodiments, software components include network application server software 617 and database software 618.

Virtualization layer 620 provides an abstraction layer from which the following examples of virtual entities may be provided: virtual servers 621; virtual storage 622; virtual networks 623, including virtual private networks; virtual applications and operating systems 624; and virtual clients 625.

In one example, management layer 630 may provide the functions described below. Resource provisioning 631 provides dynamic procurement of computing resources and other resources that are utilized to perform tasks within the cloud computing environment. Metering and Pricing 632 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 633 provides access to the cloud computing environment for consumers and system administrators. Service level management 634 provides cloud computing resource allocation and management such that required service levels are met. Service Level Agreement (S.L.A.) planning and fulfillment 635 provide pre-arrangement for, and procurement of, cloud computing resources for which a future requirement is anticipated in accordance with an S.L.A.

Workloads layer 640 provides examples of functionality for which the cloud computing environment may be utilized. Examples of workloads and functions which may be provided from this layer include mapping and navigation 641; software development and lifecycle management 1342 (e.g., the KGMatcher system 100); virtual classroom education delivery 643; data analytics processing 644; transaction processing 645; and precision cohort analytics 646.

The present invention may be a system, a method, and/or a computer program product at any possible technical detail level of integration. The computer program product may include a computer-readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (R.O.M.), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (I.S.A.) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (P.L.A.) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method for non-obvious relationship detection, the computer-implemented method comprising:
inputting a first node and a second node from a knowledge graph into a twin neural network, the twin neural network including two identical neural networks with each having a node attribute embedding layer, at least one neighbor layer, and at least one position layer;
embedding attributes of the first node and attributes of the second node separately to generate a first node embedding and a second node embedding using the node attribute embedding layer;
aggregating neighborhood information onto the first node embedding and the second node embedding using the neighbor layer;
aggregating position information onto the first node embedding and the second node embedding using the position layer;
concatenating the neighborhood information and the position information of the first node and the second node, wherein a first output vector and a second output vector is formed; and
generating a final score by comparing using a cosine distance of the first output vector to the second output vector, wherein the final score indicates a probability of a non-obvious relationship between the first node and the second node.

2. The computer-implemented method of claim 1, wherein aggregating the neighborhood information comprises:
starting with the first node embedding and the second node embedding, aggregating the neighborhood information onto the first node embedding and the second embedding in an iterative manner, with a new first node embedding and a new second node embedding acting as an initial value that is applied to a subsequent neighbor layer for a next iteration, until a predetermined number of iterations is performed.

3. The computer-implemented method of claim 1, wherein aggregating the position information comprises:
starting with the first node embedding and the second node embedding, aggregating the position information onto the first node embedding and the second embedding in an iterative manner, with a new first node embedding and a new second node embedding acting as an initial value that is applied to a subsequent position layer for a next iteration, until a predetermined number of iterations is performed.

4. The computer-implemented method of claim 1, wherein the twin neural network performs computations on the first node and the second node simultaneously on each of the identical neural networks.

5. The computer-implemented method of claim 1, wherein the neighbor layer is a GraphSage layer.

6. The computer-implemented method of claim 1, wherein the position layer is a position-aware graph neural network layer.

7. The computer-implemented method of claim 1, further comprising:
computing an error of the final score, wherein the error is an absolute difference between the final score and a ground truth label, wherein the ground truth label indicates whether the non-obvious relationship exists between the first node and the second node;
computing a backpropagation for the twin neural network using the error; and
retraining the twin neural network based on the backpropagation.

8. The computer-implemented method of claim 1, wherein the neighborhood information includes node information from nodes surrounding the first node and the second node respectively within a predetermined number of iterations from the first node and the second node.

9. The computer-implemented method of claim 1, wherein the position information includes global position information from predetermined node anchors positioned in the knowledge graph.

10. A computer program product for non-obvious relationship detection, the computer program product comprising:
one or more computer readable storage medium, and program instructions stored on the one or more computer readable storage media, the program instructions comprising:
program instructions to receive a knowledge graph, wherein the knowledge graph includes a plurality of nodes representing entities connected by edges representing relationships;
program instructions to input a first node and a second node from the knowledge graph into a twin neural network, the twin neural network including two identical neural networks with each having a node attribute embedding layer, at least one neighbor layer, and at least one position layer;
program instructions to embed attributes of the first node and attributes of the second node separately to generate a first node embedding and a second node embedding using the node attribute embedding layer;
program instructions to aggregate neighborhood information onto the first node embedding and the second node embedding using the neighbor layer;
program instructions to aggregate position information onto the first node embedding and the second node embedding using the position layer;
program instructions to concatenate the neighborhood information and the position information of the first node and the second node, wherein a first output vector and a second output vector is formed; and
program instructions to generate a final score by comparing using a cosine distance of the first output vector to the second output vector, wherein the final score indicates a probability of a non-obvious relationship between the first node and the second node.

11. The computer program product of claim 10, wherein program instruction to aggregate the neighborhood information comprises:
program instructions to start with the first node embedding and the second node embedding, aggregate the neighborhood information onto the first node embedding and the second embedding in an iterative manner, with a new first node embedding and a new second node embedding acting as an initial value that is applied to a subsequent neighbor layer for a next iteration, until a predetermined number of iterations is performed.

12. The computer program product of claim 10, wherein program instructions to aggregate the position information comprises:
program instructions to start with the first node embedding and the second node embedding, aggregate the position information onto the first node embedding and the second embedding in an iterative manner, with a new first node embedding and a new second node embedding acting as an initial value that is applied to a subsequent position layer for a next iteration, until a predetermined number of iterations is performed.

13. The computer program product of claim 10, wherein the twin neural network performs computations on the first node and the second node simultaneously on each of the identical neural networks.

14. The computer program product of claim 10, wherein the neighbor layer is a GraphSage layer.

15. The computer program product of claim 10, further comprising:
program instructions to compute an error of the final score, wherein the error is an absolute difference between the final score and a ground truth label, wherein the ground truth label indicates whether the non-obvious relationship exists between the first node and the second node;
program instructions to compute a backpropagation for the twin neural network using the error; and
program instructions to retrain the twin neural network based on the backpropagation.

16. The computer program product of claim 10, wherein the neighborhood information includes node information from nodes surrounding the first node and the second node respectively within a predetermined number of iterations from the first node and the second node.

17. The computer program product of claim 10, wherein the position information includes global position information from predetermined node anchors positioned in the knowledge graph.

18. A system for non-obvious relationship detection, the system comprising:
a memory;
a processor;
local data storage having stored thereon computer executable code;
a twin neural network including two identical neural networks configured to detect a non-obvious relationship between a first node and a second node in a knowledge graph;
a node attribute embedding layer in each of the two identical neural networks configured to entities and their corresponding entity attributes into fixed-length vectors;
at least one neighbor layer in each of the two identical neural networks configured to aggregate neighborhood information from surrounding the first node and the second node;
at least one position layer in each of the two identical neural networks configured to capture global position information for each node in the knowledge graph, wherein the position layer produces an output vector of a node embedding containing the global position information;
a merging component in each of the two identical neural networks configured to concatenate the neighborhood information and the global position information into an output vector; and
a scoring component configured to analyze the output vector of the first node and the second node and produce a final score indicating a likelihood of a non-obvious relationship between the first node and the second node.

19. The system of claim 18, wherein the twin neural network performs computations on the first node and the second node simultaneously on each of the identical neural networks.

20. The system of claim 18, wherein the neighborhood information includes node information from nodes surrounding the first node and the second node respectively within a predetermined number of iterations from the first node and the second node.
